(19) United States
(12) Patent Application Publication
(10) Pub. No.: US 2007/0079125 A1
(43) Pub. Date: Apr. 5, 2007

(54) Interface protocol method and system

(75) Inventors: Christopher Alan Adkins, Lexington, KY (US); James Ronald Booth, Nicholasville, KY (US); Timothy Lowell Strunk, Georgetown, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/236,064

(22) Filed: Sep. 27, 2005

(51) Int. Cl. H04L 9/00

(52) U.S. Cl. 713/176

(57) ABSTRACT

A claimant device includes a memory device for storing a unique claimant device identifier and a plurality of unique digital signatures. Each digital signature is based, at least in part, upon the unique claimant device identifier.

### TECHNICAL FIELD

This disclosure relates to an interface protocol and, more particularly, to an interface protocol for use in a printing device.

### BACKGROUND

Printing devices often use an electronic authentication procedure to determine if the printer cartridge installed in the printing device is an authentic printer cartridge (i.e., a printer cartridge that is allowed to be used within the printing device). Additionally, the electronic authentication procedure may determine what licensing privileges the cartridge is allowed.

The principal technique used in the electronic authentication procedure involves a “challenge” protocol in which a data set is provided to two “authentication engines”, the first being in the printer cartridge and the second being in the printing device. During authentication, both the printer cartridge and the printing device “seed” the data set with a “secret value” that is not revealed by the printer cartridge or the printing device. Typically, a digital signature (e.g., one-way hash value) of the “seeded data” is computed by the printer cartridge and the printing device. The printer cartridge then makes the digital signature available to the printing device, which compares the digital signature (computed by the printer cartridge) to a digital signature computed by the printing device. If the digital signatures match, the cartridge is authorized for use.

Unfortunately, a considerable amount of processing power may be required to generate the digital signature, which may overwhelm the processing power available on the printer cartridge.

### SUMMARY OF THE DISCLOSURE

In one implementation, a claimant device includes a memory device for storing a unique claimant device identifier and a plurality of unique digital signatures. Each digital signature is based, at least in part, upon the unique claimant device identifier.

One or more of the following features may also be included. The claimant device may be configured to be releasably coupled to a verification device. The claimant device may be a laser printer cartridge and/or an inkjet printer cartridge. The verification device may be a printing device. The claimant device may include a memory controller circuit for controlling access to the memory device. The memory controller circuit may be configured to allow the verification device to access a portion of the unique digital signatures. The portion may be less than the plurality of unique digital signatures. The memory device may include a plurality of hidden memory locations for storing the plurality of unique digital signatures. A unique signature identifier may be assigned to each of the plurality of unique digital signatures. Each unique digital signature may be based, at least in part, upon the unique signature identifier assigned to it.

In another implementation, a method includes retrieving a unique claimant device identifier from a claimant device. The unique claimant device identifier is processed to generate a processed claimant identifier. One of a plurality of unique digital signatures is retrieved from the claimant device. The retrieved unique digital signature is decrypted to generate a decrypted digital signature, which is compared to the processed claimant identifier.

One or more of the following features may also be included. The claimant device may be authenticated if the decrypted digital signature is equivalent to the processed claimant identifier. Processing the unique claimant device identifier may include combining the unique claimant device identifier with a unique signature identifier assigned to the retrieved unique digital signature to form an unprocessed claimant identifier. The unprocessed claimant identifier may be mathematically manipulated to generate the processed claimant identifier. Mathematically manipulating the unprocessed claimant identifier may include hashing the unprocessed claimant identifier to generate the processed claimant identifier.

Each digital signature may be based, at least in part, upon the unique claimant device identifier. A unique signature identifier may be assigned to each of the plurality of unique digital signatures. Each unique digital signature may be based, at least in part, upon the unique signature identifier assigned to it.

In another implementation, a computer program product residing on a computer readable medium has a plurality of instructions stored on it. When executed by a processor, these instructions cause the processor to retrieve a unique claimant device identifier from a claimant device. The unique claimant device identifier is processed to generate a processed claimant identifier. One of a plurality of unique digital signatures is retrieved from the claimant device. The retrieved unique digital signature is decrypted to generate a decrypted digital signature, which is compared to the processed claimant identifier.

One or more of the following features may also be included. The claimant device may be authenticated if the decrypted digital signature is equivalent to the processed claimant identifier. Processing the unique claimant device identifier may include combining the unique claimant device identifier with a unique signature identifier assigned to the retrieved unique digital signature to form an unprocessed claimant identifier. The unprocessed claimant identifier may be mathematically manipulated to generate the processed claimant identifier. Mathematically manipulating the unprocessed claimant identifier may include hashing the unprocessed claimant identifier to generate the processed claimant identifier.

Each digital signature may be based, at least in part, upon the unique claimant device identifier. A unique signature identifier may be assigned to each of the plurality of unique digital signatures. Each unique digital signature may be based, at least in part, upon the unique signature identifier assigned to it.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a printing device and a printer cartridge for use within the printing device;

FIG. 2 is a diagrammatic view of the printing device of FIG. 1 interfaced to the printer cartridge of FIG. 1;

FIG. 3 is a diagrammatic view illustrating the exchange of data between the printer cartridge of FIG. 1 and a manufacturing system;

FIG. 4 is a diagrammatic view illustrating the exchange of data between the printer cartridge of FIG. 1 and the printing device of FIG. 1; and

FIG. 5 is a flow chart of a process executed by the printing device of FIG. 1.

### DETAILED DESCRIPTION OF THE PREFERRED EMBODIMENTS

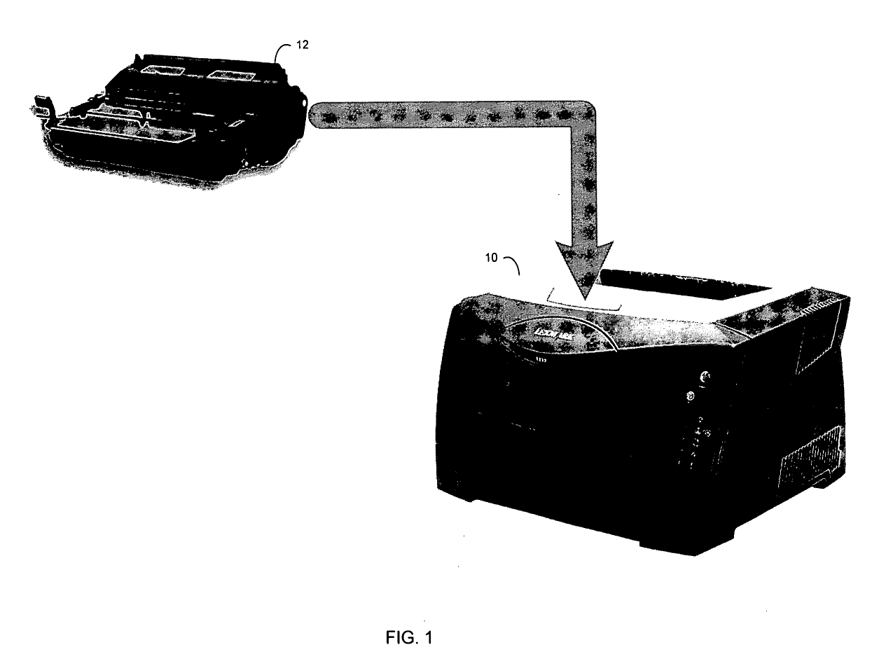

Referring to FIG. 1, there is shown a printing device 10 and a printer cartridge 12 for use within printing device 10. Printing device 10 is typically coupled to a computing device (not shown) via e.g. a parallel printer cable (not shown), a universal serial bus cable (not shown), and/or a network cable (not shown).

As is known in the art, printing device 10 is a device that accepts text and graphic information from a computing device and transfers the information to various forms of media (e.g., paper, cardstock, transparency sheets, etc.). Further and as is known in the art, a printer cartridge 12 is a component of printing device 10, which typically includes the consumables/wear components (e.g. toner, a drum assembly, and a fuser assembly, for example) of printing device 10. Printer cartridge 12 typically also includes circuitry and electronics (not shown) required to e.g., charge the drum and control the operation of printer cartridge 12.

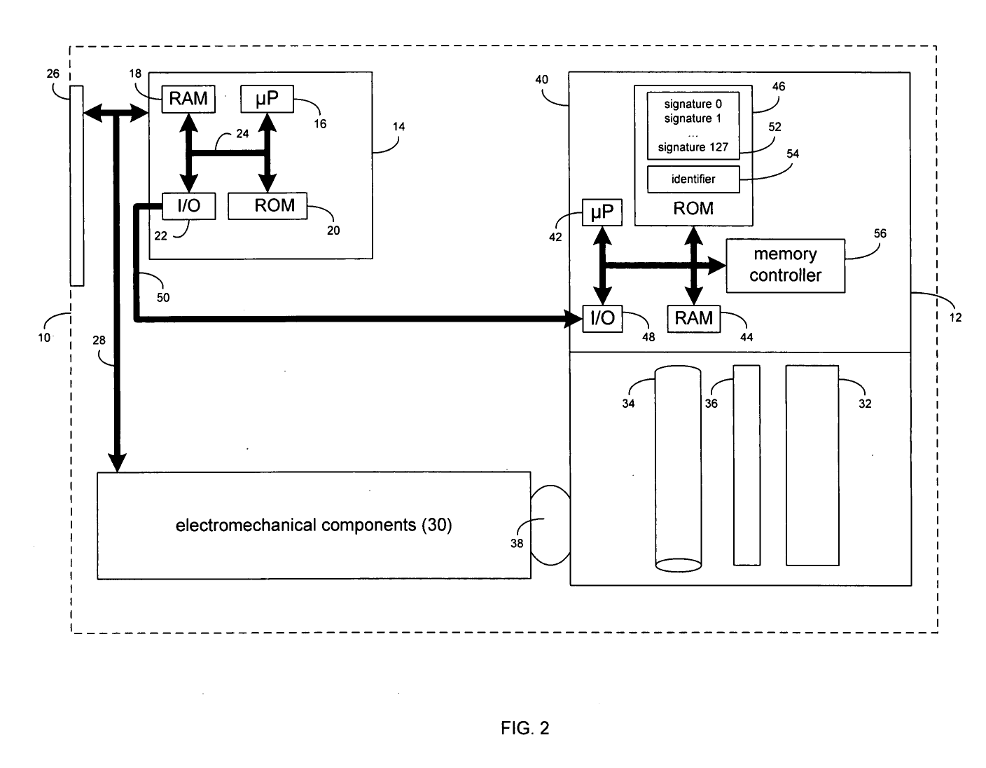

Referring also to FIG. 2, there is shown a diagrammatic view of printer cartridge 12 interfaced with printing device 10. Typically, printing device 10 includes a system board 14 for controlling the operation of printing device 10. System board 14 typically includes a microprocessor 16, random access memory (i.e., RAM) 18, read only memory (i.e., ROM) 20, and an input/output (i.e., I/O) controller 22. Microprocessor 16, RAM 18, ROM 20, and I/O controller 22 are typically coupled to each other via data bus 24. Examples of data bus 24 may include a PCI (i.e., Peripheral Component Interconnect) bus, an ISA (i.e., Industry Standard Architecture) bus, or a proprietary bus, for example.

Printing device 10 may include display panel 26 for providing information to a user (not shown). Display panel 26 may include e.g. an LCD (i.e. liquid crystal display) panel, one or more LEDs (i.e., light emitting diodes), and one or more switches. Typically, display panel 26 is coupled to I/O controller 22 of system board 14 via data bus 28. Examples of data bus 28 may include a PCI (i.e., Peripheral Component Interconnect) bus, an ISA (i.e., Industry Standard Architecture) bus, or a proprietary bus, for example. Printing device 10 typically also includes electromechanical components 30, such as: feed motors (not shown), gear drive assemblies (not shown), paper jam sensors (not shown), and paper feed guides (not shown), for example. Electromechanical components 30 may be coupled to system board 14 via data bus 28 and I/O controller 22.

As discussed above, printer cartridge 12 may include a toner reservoir 32, toner drum assembly 34, and fuser assembly 36, for example. Typically, electromechanical components 30 are mechanically coupled to printer cartridge 12 via a releasable gear assembly 38 that allows printer cartridge 12 to be removed from printing device 10.

Printer cartridge 12 typically includes a system board 40 that controls the operation of printer cartridge 12. System board 40 may include microprocessor 42, RAM 44, ROM 46, and I/O controller 48, for example. Typically, system board 40 is releasably coupled to system board 14 via data bus 50, thus allowing for the removal of printer cartridge 12 from printing device 10. Examples of data bus 50 may include a PCI (i.e., Peripheral Component Interconnect) bus, an ISA (i.e., Industry Standard Architecture) bus, an 12C (i.e., Inter-IC) bus, an SPI (i.e., Serial Peripheral Interconnect) bus, or a proprietary bus.

Typically, only an authorized printer cartridge is permitted to be used within printing device 10. Accordingly, microprocessor 16 (i.e., on system board 14) and microprocessor 42 (i.e., on system board 40) may each execute their respective portions of an authentication process that authenticates a printer cartridge for use in printing device 10. Once authenticated, a printer cartridge (e.g., printer cartridge 12) maybe used within printing device 10.

Manufacturing/Programming

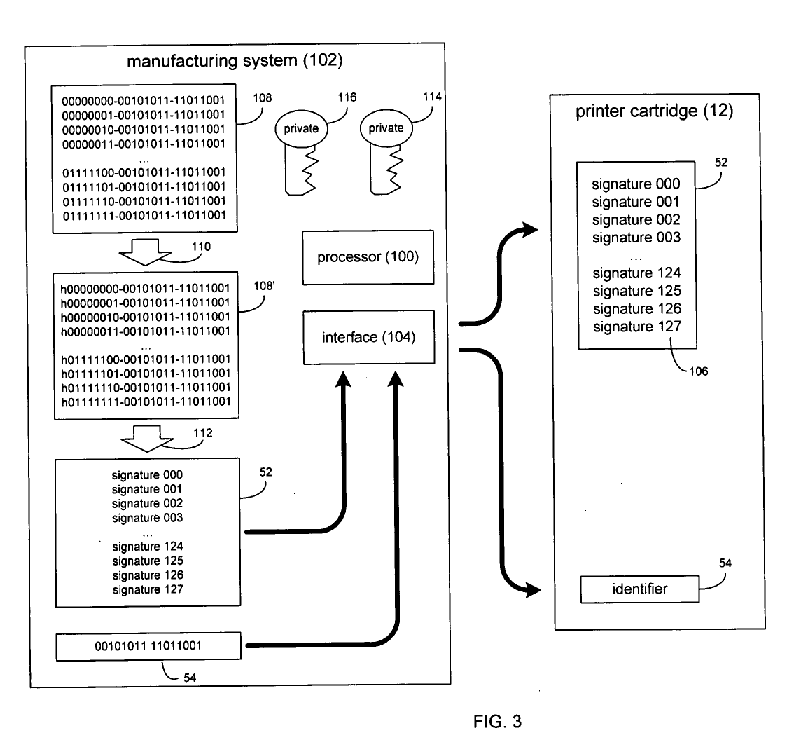

Typically and referring also to FIG. 3, at the time that printer cartridge 12 is manufactured, a plurality of unique digital signatures 52 are generated by processor 100 included within manufacturing system 102 and provided to/included within printer cartridge 12. For example, printer cartridge 12 is shown to include one-hundred-twenty-eight digital signatures 52. Typically, manufacturing system 102 includes interface components/circuitry 104 for storing digital signatures 52 within ROM 46 (e.g., EPROM and/or EEPROM, for example) of printer cartridge 12.

ROM 46 typically also includes a unique claimant device identifier 54 (e.g., a serial number) that uniquely identifies printer cartridge 12. Unique claimant device identifier 54 is typically also generated by processor 100 (included within manufacturing system 102) and provided to/included within printer cartridge 12 at the time that printer cartridge 12 is manufactured.

As is known in the art, a private key/public key encryption methodology allows devices to securely exchange data through the use of a pair of encryption keys, namely the private encryption key and the public encryption key. The private key/public key encryption methodology is typically referred to as an asymmetric encryption methodology, in that the key used to encrypt a message is different than the key used to decrypt the message.

In private key/public key encryption, the private encryption key and the public encryption key are typically created simultaneously using the same algorithm (e.g., the RSA algorithm created by Ron Rivest, Adi Shamir, and Leonard Adlemana, for example). The private key is typically given only to the requesting party and public key is typically made publicly available (e.g., typically as part of a digital certificate). The private key is typically not shared and is maintained securely.

Accordingly, when a secure message is to be sent from a sender to a recipient, the public key of the recipient (which is readily accessible to the sender) is used to encrypt the message. Once encrypted, the message may be sent to the recipient and can only be decrypted using the recipient's private key. As the private key is maintained securely by the recipient, only the recipient can decrypt the encrypted message.

In addition to encrypting and decrypting messages, a sender may authenticate their identity by using their private key to encrypt a digital certificate, which is then sent to a recipient (i.e., the person to which they are authenticating their identity). Accordingly, when the digital certificate is received by the recipient, the recipient can decrypt the encrypted digital certificate using the sender's public key, thus verifying that the digital certificate was encrypted using the sender's private key and, therefore, verifying the identity of the sender.

A digital signature is an electronic signature that uses the private key/public key encryption methodology and allows a sender of a message to authenticate their identity and the integrity of message sent. A digital signature may be used with both encrypted and non-encrypted messages and does not impede the ability of the receiver of the message to read the message.

Typically, each of the plurality of digital signatures 52 included within printer cartridge 12 is assigned a unique signature identifier 106. For example and as discussed above, if printer cartridge 12 includes one-hundred-twenty-eight digital signatures 52, a unique signature identifier 106 (e.g., ranging from 000-127) may be assigned to each of the plurality of digital signatures 52.

As discussed above, the plurality of digital signatures 52 is included within cartridge 12 at the time the cartridge is manufactured by manufacturing system 102. Typically, manufacturing system 100 generate each digital signature by combining unique claimant device identifier 54 with the unique signature identifier 106 of each digital signature. Typically, each of these combinations is then mathematically manipulated to generate each of the digital signatures.

For example, assume that manufacturing system 102 defines unique claim device identifier 54 as the 16-bit number (00101011-11011001). Further, assume that printer cartridge 12 is to include one-hundred-twenty-eight digital signatures, each of which is going to be assigned an 8-bit unique signature identifier, ranging from 000(i.e., 00000000 binary) to 127 (i.e., 0111111 binary). Accordingly, processor 100 of manufacturing system 102 may combine the binary representation of 000 (i.e. 00000000) through 127 (i.e., 11111111) with unique claim device identifier 54 (i.e., 00101011-11011001) to generate one-hundred-twenty-eight unique 24-bit numbers 108, namely (00000000-00101011-11011001) through (01111111-00101011-11011001). Each of the 24-bit numbers 108 may then be mathematically manipulated 110 (by processor 100) to generate a mathematical representation 108′ of each 24-bit number. For example, at the time of manufacture, a message hash of each 24-bit number 108 may be calculated by processor 100 of manufacturing system 102, resulting in the generation of one-hundred-twenty-eight hash values 108′, namely (h00000000-00101011-11011001) through (h01111111-00101011-11011001).

As is known in the art, a message hash is the mathematical output of a known one-way hash function that transforms a string of characters (e.g., each of the 24-bit numbers 108) into a usually shorter fixed-length value that represents the original string of characters (e.g., each of the hash values 108′). As the hashing function is a one-way mathematical function, once a message hash (e.g., h00000000-00101011-11011001) is generated, the original message (e.g., 00000000-00101011-11011001) cannot be retrieved by processing the message hash.

Manufacturing system 102 may then encrypt 112 each message hash 108′ (i.e., using private key 114) to create digital signatures 52. As discussed above, private key 114 is typically not shared and, therefore, is maintained securely within manufacturing system 102.

Authentication

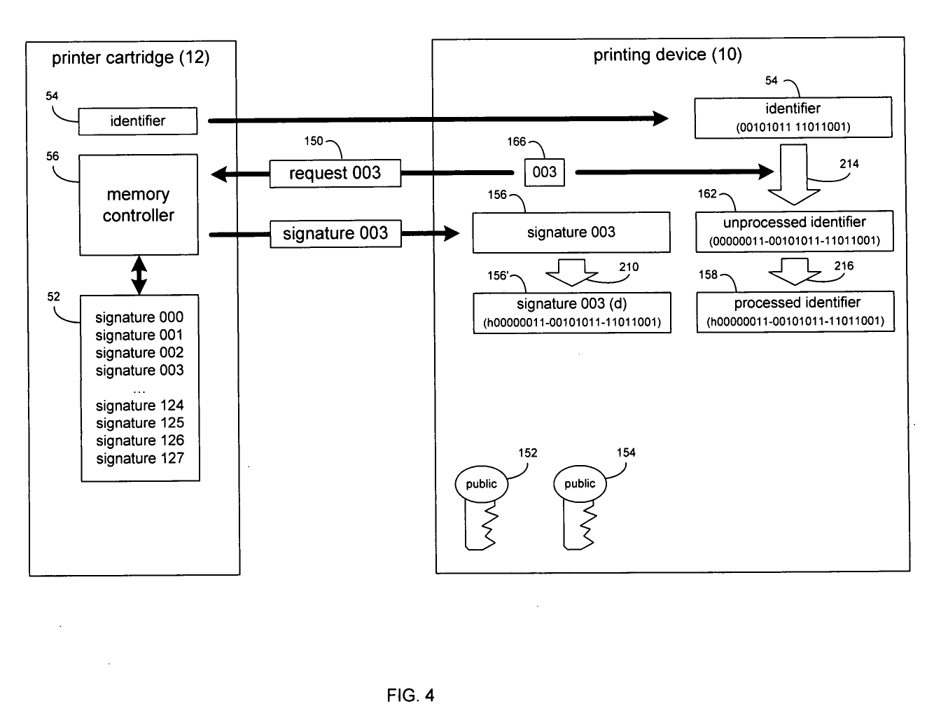

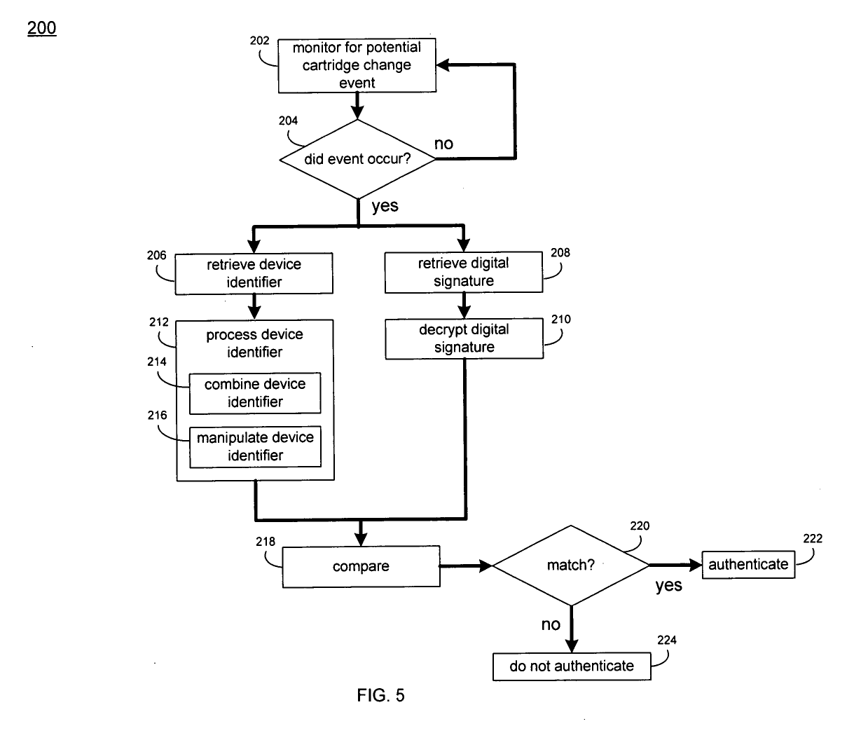

Referring also to FIGS. 4 and 5, FIG. 4 illustrates the sharing of data between printing device 10 and printer cartridge 12, while FIG. 5 illustrates an authentication process and subroutines of process and executed by microprocessor 16 using RAM 18. Other examples of the storage device include a hard disk drive or an optical drive, for example.

Process 200 monitors 202 printing device 10 for the occurrence of a potential cartridge change event (i.e., an event that may be indicative of printer cartridge 12 having been changed). Examples of a potential cartridge change event include the powering-up/resetting of printing device 10, or the opening of an access panel (not shown) on printing device 10.

If 204 a potential cartridge change event is detected, printing device 10 retrieves 206 unique claimant device identifier 54 from printer cartridge 12. Retrieving 206 unique claimant device identifier 54 may include requesting the unique claimant device identifier 54 from printer cartridge 12 and subsequently receiving unique claimant device identifier 54 from printer cartridge 12. Alternatively, unique claimant device identifier 54 may be stored in an unrestricted/non-hidden memory location within e.g., ROM 46, thus allowing printing device 10 to directly read unique claimant device identifier 54 from printer cartridge 12.

Typically, when unique claimant device identifier 54 is retrieved 206 from printer cartridge 12, unique claimant device identifier 54 is stored locally (e.g., within ROM 20 of printing device 10). Further, each time that a potential cartridge change event is detected 204, upon retrieving 206 unique claimant device identifier 54 from printer cartridge 12, the retrieved copy of unique claimant device identifier 54 is compared to the locally-stored copy of unique claimant device identifier 54 to see if a matching condition exists. If a matching condition exists, a cartridge change event did not occur (as the unique claimant device identifier 54 has not changed). Alternatively, if a matching condition does not exist, a cartridge change event did occur (as the unique claimant device identifier 54 has changed since the last time that the unique claimant device identifier 54 was retrieved from printer cartridge 12).

Process 200 retrieves 208 one of the plurality of unique digital signatures 52 stored on printer cartridge 12. Retrieving 208 one of the plurality of unique digital signatures 52 may include requesting a specific unique digital signatures (e.g., “signature 003”) from printer cartridge 12 and subsequently receiving e.g., “signature 003” from printer cartridge 12.

The specific signature requested is typically chosen randomly. For example, printing device 10 is configured to work with printing cartridge 12 and, accordingly, printing cartridge 12 is configured to work with printing device 10. Therefore, printing device 10 is knowledgeable of the number of digital signatures stored within printer cartridge 12. As discussed above, in this particular example, printer cartridge 12 includes one-hundred-twenty-eight digital signatures 52. Accordingly, printing device 10 may randomly select a value between 000 and 127 (which are representative of the one-hundred-twenty-eight digital signatures stored within printer cartridge 12). Continuing with the above-stated example, if printing device 10 randomly selects “signature 003”, the appropriate request 150 is provided to printer cartridge 12.

Typically, the plurality of digital signatures 52 are stored within “hidden” memory lactations within ROM 46. For example, ROM 46 may include one-hundred-twenty-eight “hidden” memory locations for storing the one-hundred-twenty-eight digital signatures 52. Access to ROM 46 (generally) and the “hidden” memory locations within ROM 46 (specifically) is controlled by memory controller 56 included within printer cartridge 12. Memory controller 56 acts as a gatekeeper and receives and processes the digital signature requests (e.g., request 150) generated by printing device 10.

Continuing with the above-stated example, if request 150 includes a request for “signature 003” chosen from the plurality of digital signatures 52 included within printer cartridge 12, memory controller 56 may determine the “hidden” memory location (within e.g., ROM 46) of “signature 003”, retrieve “signature 003” from that “hidden” memory location, and provide “signature 003” to printing device 10.

As discussed above, private key 114 (FIG. 3) is used to encrypt the plurality of digital signatures 52 included within printer cartridge 12. Accordingly and as discussed above, each digital signature included within the plurality of digital signature 52 may be decrypted using a corresponding public key 152. Public key 152 may be stored within printing device 10 at the time of manufacture or may be retrieved from printer cartridge 12.

For example, if a single private key (e.g., private key 114 of FIG. 4) is used to encrypt the digital signatures stored within all of the printer cartridges (e.g., printer cartridge 12) that may be used within printing device 10, only a single public key would be needed to decrypt the digital signatures. Accordingly and in this example, public key 152 may be stored within printing device 10 at the time that printing device 10 is manufactured.

However, if one of a plurality of private keys may be used to encrypt the digital signatures stored within all of the printer cartridges (e.g., printer cartridge 12) that may be used within printing device 10, one of a plurality of public keys would be needed to decrypt the digital signatures. Accordingly and in this example, public key 152 may be retrieved from printer cartridge 12 and, therefore, may be stored within printer cartridge 12 at the time of manufacture. If public key 152 is stored on and retrieved from printer cartridge 12, public key 152 may be digitally signed by manufacturing system 102 (using a master private key 116) prior to being stored within printer cartridge 12. Accordingly and in this example, once printing device 10 retrieves the digitally-signed version of public key 152 from printer cartridge 12, printing system 10 may use master public key 154 (stored within printing device 10 at the time of manufacture) to verify the integrity of public key 152.

Once retrieved 208 from printer cartridge 12, the retrieved digital signature 156 (e.g., “signature 003”) may be decrypted 210 (using public key 152) to generate decrypted digital signature 156′.

As discussed above, when generating the one-hundred-twenty-eight digital signatures included within printer cartridge 12, processor 100 of manufacturing system 102 may combine the binary representation of 000 (i.e. 00000000) through 127 (i.e., 11111111) with unique claim device identifier 54 (i.e., 00101011-11011001) to generate one-hundred-twenty-eight unique 24-bit numbers 108, namely (00000000-00101011-11011001) through (01111111-00101011-11011001). These one-hundred-twenty-eight unique 24-bit numbers 108 may then be mathematically manipulated 110 (e.g., hashed) to generate one-hundred-twenty-eight hash values 108′, namely (h00000000-00101011-11011001) through (h01111111-00101011-11011001). Manufacturing system 102 may then encrypt 112 each message hash 108′(i.e., using private key 114) to create digital signatures 52. Accordingly, by decrypting 210 retrieved digital signature 156, the original hash value associated with retrieved digital signature 156 may be obtained.

For example and as discussed above, when generating “signature 003” (i.e., retrieved signature 156), 00000011 (i.e., the signature identifier for “signature 003”) was combined with 00101011-11011001 (i.e., unique claimant device identifier 54) to form (00000011-00101011-11011001), which was subsequent hashed 110 (i.e., forming h00000011-00101011-11011001) and encrypted 112 (i.e., forming “signature 003”). Accordingly, decrypting 210 retrieved digital signature 156 generates decrypted digital signature 156′ (i.e., h00000011-00101011-11011001).

As discussed above, printing device 10 retrieves 206 unique claimant device identifier 54 from printer cartridge 12. Once retrieved 206, unique claimant device identifier 54 is processed 212 to generate a processed claimant identifier 158. Processing 212 unique claimant device identifier 54 may include combining 214 unique claimant device identifier 54 with the unique signature identifier assigned to retrieved digital signature 156 to form unprocessed claimant identifier 162. Unprocessed claimant identifier 162 may then be mathematically manipulated 216 (e.g., hashed) to generate processed claimant identifier 158.

For example and as discussed above, printing device 10 provides request 150 to printer cartridge 12, such that request 150 requests “signature 003”. Accordingly, the unique signature identifier 166 associated with the requested digital signature is “003”. The binary representation (i.e., 00000011) of signature identifier 166 is combined 214 with unique claimant device identifier 54 (i.e., 00101011-11011001) to form unprocessed claimant identifier 162 (i.e., 00000011-00101011-11011001). Unprocessed claimant identifier 162 (i.e., 00000011-00101011-11011001) may then be mathematically manipulated 216 (e.g., hashed) to generate processed claimant identifier 158 (i.e., h00000011-00101011-11011001).

When mathematically manipulating 216 unprocessed claimant identifier 162 to generate processed claimant identifier 158, the mathematical manipulation 216 should be the same as that which was performed by manufacturing system 102. For example, if a hash function was performed (by manufacturing system 102) to mathematically manipulate 110 the 24-bit numbers 108, the identical hash function should be performed by printing device 10.

Process may compare 218 processed claimant identifier 158 and decrypted digital signature 156′ to determine 220 if a matching condition exists. If a matching condition exists, printer cartridge 12 is authenticated 222 and, therefore, will function properly within printing device 10. However, if a matching condition does not exist, printer cartridge 12 is not authenticated 224 and, therefore, printing device 10 will be prohibited from functioning until the non-authenticated printer cartridge is removed and replaced with an authenticated printer cartridge.

As discussed above, the plurality of digital signatures 52 are stored within “hidden” memory lactations within ROM 46. Further and as discussed above, memory controller 56 may act as a gatekeeper and receive and process the digital signature request 150 generated by printing device 10. Memory controller 56 may be configured to monitor the total number of “hidden” memory locations accessed by the printing devices (e.g., printing device 10) into which printer cartridge 12 is placed, and only allow access to a defined number or percentage of the “hidden” memory locations. Printer cartridge 12 is described above as including one-hundred-twenty-eight “hidden” memory locations for storing one-hundred-twenty-eight digital signatures. Accordingly, memory controller 56 may be configured to only allow access to e.g., sixty-four of those memory locations. Accordingly, each time a unique memory location is accessed, a location counter (not shown) may be incremented by memory controller 56, thus monitoring the total number of memory locations accessed. In the event that providing access to a memory location (and, therefore, the digital signature included within that memory location) would result in the total number of memory locations accessed (e.g., sixty-five) exceeds the maximum number of accessible memory locations (e.g., sixty-four), the above-described authentication process may fail, resulting in printing device 10 being prohibited from functioning until the non-authenticated printer cartridge is removed and replaced with an authenticated printer cartridge.

While printer cartridge 12 is shown and discussed above as being a laser printer cartridge 12, other configurations are possible and are considered to be within the scope of this disclosure. For example, printer cartridge 12 may be an inkjet printer cartridge and printing device 10 may be an inkjet printer.

A number of implementations have been described. Nevertheless, it will be understood that various modifications may be made. Accordingly, other implementations are within the scope of the following claims.

What is claimed is:

1. A claimant device comprising:
a memory device for storing:
a unique claimant device identifier; and
a plurality of unique digital signatures, wherein each digital signature is based, at least in part, upon the unique claimant device identifier.

2. The claimant device of claim 1 wherein the claimant device is configured to be releasably coupled to a verification device.

3. The claimant device of claim 2 wherein the claimant device is a laser printer cartridge.

4. The claimant device of claim 2 wherein the claimant device is an inkjet printer cartridge.

5. The claimant device of claim 2 wherein the verification device is a printing device.

6. The claimant device of claim 1 further comprising:
a memory controller circuit for controlling access to the memory device, wherein the memory controller circuit is configured to allow the verification device to access a portion of the unique digital signatures, wherein the portion is less than the plurality of unique digital signatures.

7. The claimant device of claim 1 wherein the memory device includes:
a plurality of hidden memory locations for storing the plurality of unique digital signatures.

8. The claimant device of claim 1 wherein a unique signature identifier is assigned to each of the plurality of unique digital signatures, and each unique digital signature is based, at least in part, upon the unique signature identifier assigned to it.

9. A method comprising:
retrieving a unique claimant device identifier from a claimant device;
processing the unique claimant device identifier to generate a processed claimant identifier;
retrieving one of a plurality of unique digital signatures from the claimant device;
decrypting the retrieved unique digital signature to generate a decrypted digital signature; and
comparing the decrypted digital signature to the processed claimant identifier.

10. The method of claim 9 further comprising:
authenticating the claimant device if the decrypted digital signature is equivalent to the processed claimant identifier.

11. The method of claim 9 wherein processing the unique claimant device identifier includes:
combining the unique claimant device identifier with a unique signature identifier assigned to the retrieved unique digital signature to form an unprocessed claimant identifier; and
mathematically manipulating the unprocessed claimant identifier to generate the processed claimant identifier.

12. The method of claim 11 wherein mathematically manipulating the unprocessed claimant identifier includes:
hashing the unprocessed claimant identifier to generate the processed claimant identifier.

13. The method of claim 9 wherein each digital signature is based, at least in part, upon the unique claimant device identifier.

14. The method of claim 9 wherein a unique signature identifier is assigned to each of the plurality of unique digital signatures, and each unique digital signature is based, at least in part, upon the unique signature identifier assigned to it.

15. A computer program product residing on a computer readable medium having a plurality of instructions stored thereon which, when executed by a processor, cause the processor to:
retrieve a unique claimant device identifier from a claimant device;
process the unique claimant device identifier to generate a processed claimant identifier;
retrieve one of a plurality of unique digital signatures from the claimant device;
decrypt the retrieved unique digital signature to generate a decrypted digital signature; and
compare the decrypted digital signature to the processed claimant identifier.

16. The computer program product of claim 15 further comprising instructions for:
authenticating the claimant device if the decrypted digital signature is equivalent to the processed claimant identifier.

17. The computer program product of claim 15 wherein the instructions for processing the unique claimant device identifier include instructions for:
combining the unique claimant device identifier with a unique signature identifier assigned to the retrieved unique digital signature to form an unprocessed claimant identifier; and
mathematically manipulating the unprocessed claimant identifier to generate the processed claimant identifier.

18. The computer program product of claim 17 wherein the instructions for mathematically manipulating the unprocessed claimant identifier include instructions for:
hashing the unprocessed claimant identifier to generate the processed claimant identifier.

19. The computer program product of claim 15 wherein each digital signature is based, at least in part, upon the unique claimant device identifier.

20. The computer program product of claim 15 wherein a unique signature identifier is assigned to each of the plurality of unique digital signatures, and each unique digital signature is based, at least in part, upon the unique signature identifier assigned to it.
